(19) United States
(12) Patent Application Publication
(10) Pub. No.: US 2007/0025567 A1
(43) Pub. Date: Feb. 1, 2007

(54) Microphone comprising an hf transmitter

(76) Inventor: Matthias Fehr, Langenhagen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/552,085

(22) PCT Filed: Mar. 29, 2004
(86) PCT No.: PCT/EP04/03298

§ 371 Date: Oct. 4, 2005

(30) Foreign Application Priority Data
Apr. 4, 2003 (DE) 103 15 744.1

(51) Int. Cl. H04R 3/00

(52) U.S. Cl. 381/113

(57) ABSTRACT

The invention concerns a wireless microphone system. The object of the present invention is to further develop such wireless microphone systems. A further aim of the invention is to provide an improvement in the intermodulation spacing of HF transmitters so that more transmitters can be used in the same frequency band. A wireless microphone system comprising antennae connected thereto, wherein a circulator and/or an HF isolator is connected to the antennae or the antenna.

### CROSS-REFERENCE TO RELATED APPLICATIONS

This application claims priority of International Application No. PCT/EP2004/003298, filed Mar. 29, 2004, and German Application No. 103 15 744.1, filed Apr. 4, 2003, the complete disclosures of which are hereby incorporated by reference.

### BACKGROUND OF THE INVENTION

a) Field of the Invention

The invention concerns a wireless microphone system.

b) Description of the Related Art

Such wireless microphones are already used in many different ways. In that respect attention is to be directed to the catalog from Lectrosonics Inc, USA: UHF Wireless Microphone Catalog 03/03, page 4, U.S. Pat. No. 4,430,619 and DE 2 226 515 A.

### OBJECT AND SUMMARY OF THE INVENTION

The primary object of the present invention is to further develop such wireless microphone systems. A further aim of the invention is to provide an improvement in the intermodulation spacing of HF transmitters so that more transmitters can be used in the same frequency band.

The invention is not just limited to wireless microphone systems alone but includes all HF transmitters with a removable antenna.

In this connection, it must be pointed out that it is already known for HF circulators, isolators or filters to be fixedly installed in HF transmitters or wireless microphones, which have to be suitably exchanged upon a change in frequency. It is apparent that that exchange operation is fairly complicated and expensive and often also gives rise to difficult technical problems.

According to the invention the object thereof is attained by a wireless microphone system comprising antennae connected thereto. A circular and/or HF isolator is connected to the antennae or antenna. The circulator and/or HF isolator is integrated in the antenna. The two form a mechanical unit. The circulator and/or HF isolator is integrated in the antenna by being plugged in or screwed on.

In accordance with the invention the antenna or the antennae of the wireless systems according to the invention have a circulator/HF isolator fixedly associated therewith or are connected to such a circulator/HF isolator, wherein said circulator/HF isolator can then also be disposed in the transmitting or receiving device respectively. A particular advantage however is enjoyed if an antenna can be pluggably fitted to the transmitting or receiving device and the circulator/HF isolator is also integrated in the antenna. More specifically in that case the entire antenna is pre-tuned to a desired range and does not need to be later adjusted separately once again. It is also advantageous if, in the case of an integrated antenna—for example in a hand-held wireless microphone (hand transmitter)—the antenna is electrically and mechanically connected to the circulator/HF isolator and that antenna-circulator/HF isolator unit can be replaced as a complete structural group. The same applies for receiving devices.

A circulator/HF isolator usually has a low level of transmission attenuation in the transmitting or receiving direction and a high level of blocking attenuation in opposite relationship to the transmitting or receiving direction respectively. The impedance at the input of the circulator/HF isolator is constant and independent of the impedance of subsequent components. In that way, in the case of transmitting devices, it is ensured that the transmitting amplifier can operate in a constant operating range. Thus for example upon touching of—and thus de-tuning of—the antenna, that results in a lower level of feedback to the transmitting amplifier or the entire transmitting device. An essential advantage of decoupling of the antenna from the transmitting amplifier by a circulator/HF isolator is that two adjacent transmitters only still slightly influence each other; intermodulation between the transmitters is greatly reduced. In that way a plurality of transmitter microphones can co-operate in an interference-free manner in a narrower frequency range. Frequency economy is improved. In the converse situation, the tuning range in which the transmitters are to operate can be increased, with the same technical properties (intermodulation products).

The solution according to the invention, of the pluggable/interchangeable mechanical unit of the antenna and the circulator/HF isolator, provides that it is possible to associate with each wireless microphone, the optimum antenna combination allocated to the respective working frequency range. That applies not only for freshly installed wireless microphone installations but in particular also for systems which are already in operation. By retro-fitting of wireless microphone systems which are in operation, it is possible to markedly reduce interference thereof, due to adjacent-channel transmitting installations operated in the same installation. Then, additional wireless microphones can be operated in the same frequency range; that considerably increases frequency economy. That is of significance in particular in the case of wireless microphone systems with many microphones, for example on theater/musical stages.

The use of circulators is also of significance if antennae with a different directional characteristic, for example with linear polarisation or circular polarisation, are to be operated at a predetermined transmitting amplifier of a wireless microphone. Here too the circulator/HF isolator permits a high degree of decoupling from the transmitting amplifier and thus provides for an optimum working range. The solution according to the invention, by virtue of the mechanical unit of the antenna and the circulator/HF isolator, permits optimum matching of both components. In production or subsequently at the user, the frequency range and/or the antenna characteristic can be adapted easily and without any problem, by virtue of the pluggable/interchangeable antenna-circulator/HF isolator unit.

There are two configurations for handheld transmitter microphones (hand transmitters): hand transmitters with fixedly connected or plugged-in antenna and designs with an antenna which is integrated in the housing. The same applies for plugged-in antennae, as for the above-described pocket transmitters. For hand microphones with an antenna which is integrated in the housing, an appropriate design configuration is one in which the antenna and the circulator/HF isolator are mechanically jointly disposed in a separate joint housing. That is then exchanged upon a change in frequency.

In substance, the foregoing discussion also applies in regard to the receivers needed for a wireless microphone system. In this case also the level of receiver sensitivity or the (receiver) intermodulation spacing can be improved by the incorporation of a circulator/HF isolator into the high frequency branch of the receiver. In this case also more receivers can be operated in an existing frequency range, which is suitable for the above-mentioned operation of more transmitters by utilising the circulators/HF isolators in the transmitter output. In this case too frequency economy can be improved.

On the other hand, with the use of circulators/HF isolators in the high frequency branch of the receivers, it is possible to substantially enlarge the (tunable) receiving frequency band width of the receivers. That affords the user the possibility of rapidly adapting to the frequencies which can be used at the place of use.

With the solution according to the invention of the pluggable/interchangeable mechanical unit of (receiving) antenna-circulator/HF isolator, the user, besides the frequency change in the receiver, only has to exchange the antenna-circulator/HF isolator unit. That affords quick and uncomplicated adaptation in the current operating situation.

The foregoing description applies inclusive of the pocket receivers which are usual in wireless microphone systems, as are used for example in talk shows for transmission or for musicians in the form of what are referred to as in-ear monitor systems. In this case also a plurality of wireless systems can be operated in the same frequency range by means of the solution according to the invention by virtue of a reduction in intermodulation by the antenna-circulator/HF isolator unit.

The particular advantages of the invention are that more transmitters than hitherto can be implemented in a frequency band, a change in frequency can be very easily effected and even existing HF transmitters, transmitting installations and also wireless microphones can be easily retro-fitted.

The invention is described in greater detail hereinafter by means of an embodiment illustrated in the drawings.

### BRIEF DESCRIPTION OF THE DRAWINGS

In the drawings:

FIG. 1 shows a plan view of an HF transmitter with a circulator (HF isolator) disposed in an antenna in accordance with the present invention; and

FIG. 2 shows a perspective view of a microphone with an antenna in accordance with the present invention.

### DESCRIPTION OF THE PREFERRED EMBODIMENTS

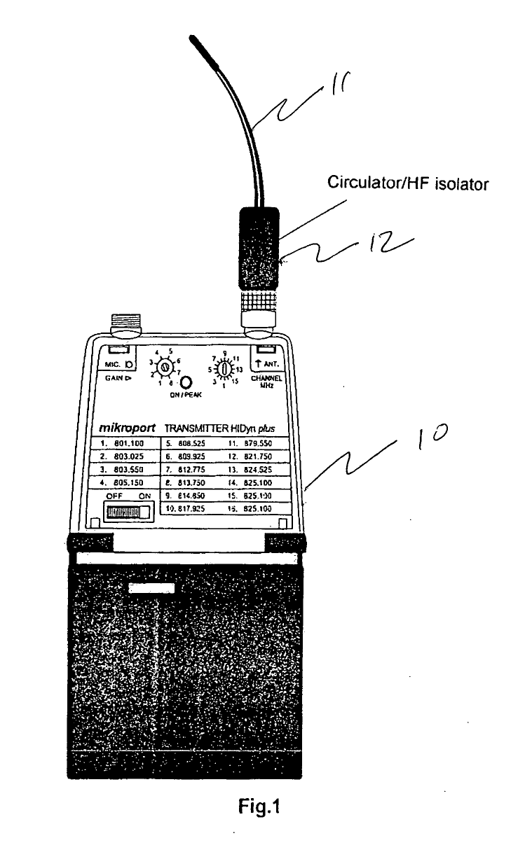

Referring once again to the figures, a transmitter 10 has an antenna 11 with a circular (HF isolator) 12 disposed in the antenna as shown in FIG. 1.

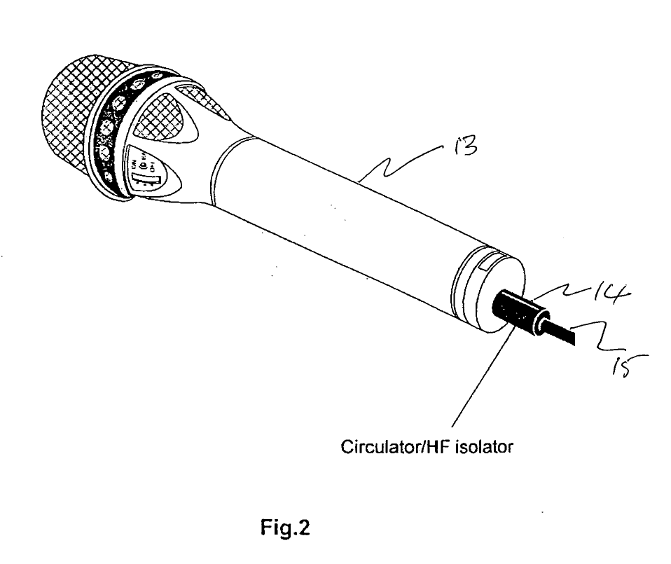

In FIG. 2, a microphone 13 is shown having an antenna 15. A circular and/or HF isolator is disposed in the antenna so that the respective frequency band can be easily set by replacement of the antenna.

Insofar as a wireless microphone system is described in the present application, it will be appreciated that this applies not only restricted thereto, but basically for an HF transmitter having an antenna.

It is also particularly advantageous for the antenna to be externally provided with an identification, that identification being associated with the respective frequency range of the circulator and/or the circulator unit. The identification can for example consist of a coding or also a color identification, so that the expert, in this case a sound technician or a sound engineer, can already very readily recognise from a certain distance, the frequency to which the HF transmitter of the wireless microphone is tuned or the frequency at which it is operating.

The circulator or HF isolator can be provided with tuning means in order if necessary to tune it to a given frequency range or frequency response.

While the foregoing description and drawings represent the present invention, it will be obvious to those skilled in the art that various changes may be made therein without departing from the true spirit and scope of the present invention.

1-13. (canceled)

14. A wireless microphone system comprising:
antennae connected thereto;
a circulator and/or an HF isolator being connected to the antennae or the antenna; and
said circulator and/or HF isolator being integrated in the antenna and the two forming a mechanical unit.

15. The wireless microphone system wherein said circulator and/or HF isolator is integrated in the antenna by being plugged in or screwed on.

16. The wireless microphone system as set forth in claim 14, wherein the wireless microphone comprises a hand transmitter microphone or a pocket transmitter microphone and a (diversity) receiver.

17. The wireless microphone system as set forth in claim 14, wherein the circulator/HF isolator is integrated in the antenna (which can be plugged in or screwed on) and the two form a mechanical unit.

18. A pocket transmitter microphone as set forth in claim 16, wherein the antenna provided with the circulator/HF isolator is pluggably connected to the transmitting device of the microphone and that the antenna, circulator/HF isolator and plug device form a mechanical unit.

19. A hand transmitter microphone as set forth in claim 16, wherein the antenna which is mechanically fixedly connected to the circulator/HF isolator is disposed in a common housing and is replaceable as a unit.

20. The microphone as set forth in claim 14, wherein the pluggable or replaceable antenna-circulator/HF isolator unit is tuned to a given frequency range.

21. The wireless microphone device wherein the receiving device also has in its high frequency input a circulator/HF isolator.

22. The wireless microphone system as set forth in claim 21, wherein the receiving antenna is fixedly connected to a circulator/HF isolator.

23. The wireless microphone system as set forth in claim 21, wherein the receiving antenna with the circulator/HF isolator is at least partially disposed in a common housing.

24. The wireless microphone system as set forth in claim 21, wherein the receiver carried on the body is provided with a pluggable or replaceable antenna-circulator/HF isolator unit.

25. The wireless microphone system as set forth in claim 21, wherein the antenna-circulator/HF isolator unit is tuned to a given frequency range.

26. An HF transmitter comprising:
an antenna connected thereto, said antenna being in accordance with claim 14 and being integrated into or connected to a circulator and/or an HF isolator.

27. The HF transmitter or system as set forth in claim 26, wherein the antenna externally includes a visible identification, coding or color marking or the like, the identification, coding or color marking being attributed to a given frequency range.
